(19) United States
(12) Patent Application Publication
(10) Pub. No.: US 2025/0317379 A1
(43) Pub. Date: Oct. 9, 2025

(54) VARYING PATH GROUP SPEED BASED ON SUSTAINABILITY TARGETS

(71) Applicant: INTERNATIONAL BUSINESS MACHINES CORPORATION, ARMONK, NY (US)

(72) Inventors: PASQUALE A. CATALANO, WALLKILL, NY (US); JOHN S. WERNER, FISHKILL, NY (US); ARKADIY O. TSFASMAN, WAPPINGERS FALLS, NY (US); ANDREW GERALD CRIMMINS, MONTROSE, NY (US)

(21) Appl. No.: 18/625,613

(22) Filed: Apr. 3, 2024

(51) Int. Cl. H04L 45/121

(52) U.S. Cl. CPC H04L 45/121

(57) ABSTRACT

Varying path group speed based on sustainability targets includes identifying, in a first network, a path group consisting of a plurality of data paths between a first endpoint and a second endpoint, the plurality of data paths including at least a first data path and a second data path, wherein a first link speed of the first data path is slower than a second link speed of the second data path; determining a latency value associated the first data path; and adjusting, in response to the latency value associated with the first data path meeting a service level requirement, a path selection mechanism to favor the first data path over the second data path.

### BACKGROUND

The present disclosure relates to methods, apparatus, and products for varying path group speed based on sustainability targets. Enterprises are increasingly scrutinizing their carbon footprint and making efforts to improve their environmental impact. As every aspect of a digital presence requires some amount of energy consumption, it is difficult to monitor all of these aspects to ensure that the system as a whole is meeting sustainability goals and targets.

### SUMMARY

According to embodiments of the present disclosure, various methods, apparatus and products for varying path group speed based on sustainability targets are described herein. In some aspects, varying path group speed based on sustainability targets includes identifying, in a first network, a path group consisting of a plurality of data paths between a first endpoint and a second endpoint. The plurality of data paths includes at least a first data path and a second data path, where a first link speed of the first data path is slower than a second link speed of the second data path. A latency value associated the first data path is determined. In response to the latency value associated with the first data path meeting a service level requirement, a path selection mechanism is adjusted to favor the first data path over the second data path. In this way, the energy demand of data transport can be optimized by determining which paths are overachieving service level targets, and thus consuming more power than needed, and adjusting path selection mechanisms to favor paths that are associated with a relatively smaller energy demand. Further, using path utilization information and service level metrics, embodiments can reduce the link speed of paths that are overachieving service level targets.

### BRIEF DESCRIPTION OF THE DRAWINGS

FIG. 1 sets forth a block diagram of an example network environment according to aspects of the present disclosure.

FIG. 2 sets forth an example computing environment according to aspects of the present disclosure.

FIG. 3A sets forth a block diagram of another example network environment for varying path group speed based on sustainability targets in accordance with at least one embodiment of the present disclosure.

FIG. 3B sets forth a block diagram of another example network environment for varying path group speed based on sustainability targets in accordance with at least one embodiment of the present disclosure.

FIG. 3C sets forth a block diagram of another example network environment for varying path group speed based on sustainability targets in accordance with at least one embodiment of the present disclosure.

FIG. 4 sets forth a block diagram of an example I/O management module for varying path group speed based on sustainability targets in accordance with at least one embodiment of the present disclosure.

FIG. 5 sets forth a flow chart of an example method for varying path group speed based on sustainability targets in accordance with at least one embodiment of the present disclosure.

FIG. 6 sets forth a flow chart of another example method for varying path group speed based on sustainability targets in accordance with at least one embodiment of the present disclosure.

FIG. 7 sets forth a flow chart of another example method for varying path group speed based on sustainability targets in accordance with at least one embodiment of the present disclosure.

FIG. 8 sets forth a flow chart of another example method for varying path group speed based on sustainability targets in accordance with at least one embodiment of the present disclosure.

### DETAILED DESCRIPTION

In Fibre Channel fabrics, as well as other types of networks, endpoints and fabric devices will negotiate link speeds to the highest available speed. Because higher-speed fiber optic links consume more power, and lasers are always on and sending idle sequences regardless of link utilization percentage, utilizing the highest available speed results in high power consumption. This can lead to wasted energy consumption if links are not fully utilized and service level requirements are exceeded. Further, data paths in the fabric may be integrated into larger data paths that traverse other networks. As such, maintaining high speeds within the fabric may not improve end-to-end service level metrics if bottlenecks are occurring in the other networks or elsewhere in the software stack. In such cases, using a high link speed in the fabric may have minimal impact to the overall service level, so the fabric is wasting power by configuring data paths to use the highest available link speed. This unnecessary energy consumption has an adverse impact on the efficiency and performance of data transport systems and may also run counter to sustainability targets set for such systems.

As used herein, ‘sustainability’ refers to environmental and ecological sustainability and the capacity to promote so-called ‘green’ initiatives such as energy, resource, and ecological conservation and mitigation against water pollution, air pollution, fossil-fuel depletion, ozone depletion, climate change, and so on. Thus, the feature of reducing environmental and ecological impact and promoting sustainability is herein synonymous with the term ‘green.’ To that end, as used herein a ‘sustainability target’ is a limit on factor (e.g., energy demand) that contributes to the environmental and ecological impact by a particular aspect of technology. In the context of data transport between two endpoints, the energy demand of sending a packet from one device to is a factor that can be minimized to meet sustainability targets. For example, the energy demand of a data path is minimized if the link is configured to operate at the lowest speed that will still meet service level requirements, where faster links are associated with greater energy demand (e.g., due to the energy demand of lasers in a fiber optic link).

Embodiments in accordance with aspects of the present disclosure leverage a variation in link speeds across redundant path to identify when a lower link speed can be utilized without violating service level requirements and targets. In some examples, an input/output (I/O) management module identifies when paths associated with slower link speeds are meeting service level requirements and adjusts a path selection mechanism based on this information. Instead of using round robin or some other path selection policy, the I/O management module adjusts the path selection mechanism to favor paths in the path group that are associated with the slower link speed. The I/O management module can also reduce the link speed of a path in response to determining that the path is overachieving the service level requirements, or in response to determining that the path is underutilized. By reducing link speeds, energy demand associated with transporting data is reduced, thereby advancing sustainability goals, and the overall performance and efficiency of the data transport system is improved.

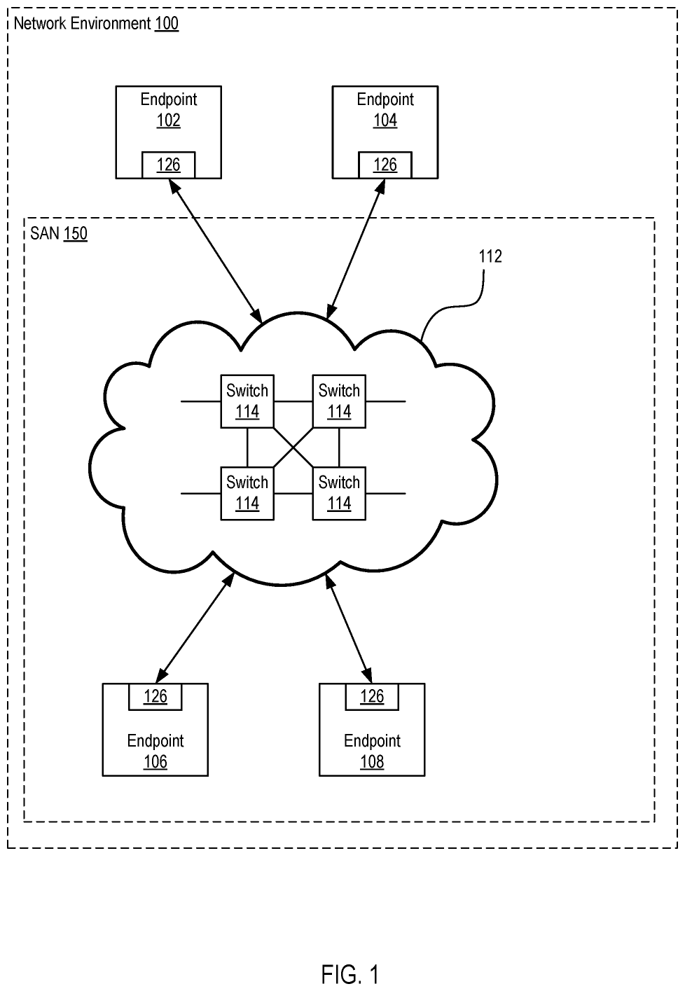

With reference now to FIG. 1, FIG. 1 sets forth an example network environment 100 for varying path group speed based on sustainability targets in accordance with the present disclosure. Network environment 100 includes a number of endpoints 102, 104, 106, 108. Endpoints 102, 104, 106, 108 may be embodied as, for example, a server, a workstation, a mainframe, a personal computer, a notebook, a storage device, and the like. Each endpoint 102, 104, 106, 108 includes one or more host bus adapters 126, implemented in software or hardware, that connect the endpoints 102, 104, 106, 108 to a switched fabric 112. The switched fabric 112 includes a number or switches 114 configured to receive packets of data from initiated by a source endpoint and route the packets to a next switch or device (also referred to herein as a ‘next hop’) in route to a particular target endpoint.

The switched fabric 112 is configured to utilize a variety of different protocols and fabric topologies to facilitate data communications between components of the network environment 100. For example, the switched fabric 112 can include Fibre Channel (‘FC’) technologies such as FC fabrics and FC protocols that can transport SCSI commands over FC networks. The switched fabric 112 can also include FC over ethernet (‘FCoE’) technologies through which FC frames are encapsulated and transmitted over Ethernet networks. The switched fabric 112 can also include InfiniBand (‘IB’) technologies in which a switched fabric topology is utilized to facilitate transmissions between channel adapters. It will be appreciated that other switched fabric topologies can be utilized in accordance with aspects of the present disclosure.

In a particular example, network environment 100 includes a storage area network (SAN) 150 in which some endpoint 106, 108 are data storage devices such as storage arrays, tape storage, and the like. In such an example, other endpoints 102, 104, acting as host devices, issue storage commands to endpoints 106, 108 through switched fabric 112. The SAN 150 may be implemented with a variety of data communications fabrics, devices, and protocols. For example, the fabrics for SAN 150 may include Fibre Channel, Ethernet, Infiniband, Serial Attached Small Computer System Interface (‘SAS’), or the like. Data communications protocols for use with SAN 150 may include Advanced Technology Attachment (‘ATA’), Fibre Channel Protocol, Small Computer System Interface (‘SCSI’), Internet Small Computer System Interface (‘iSCSI’), HyperSCSI, Non-Volatile Memory Express (‘NVMe’) over Fabrics, or the like.

In a particular example, the switched fabric 112 is a Fibre Channel fabric. A Fibre Channel fabric employs a mesh topology allowing multiple routes for data to travel between endpoints. This redundancy enhances fault tolerance and reliability. In such an example, the switches 114 are configured as Fibre Channel switches that are coupled by Fibre Channel links. A Fibre Channel switch can include, for example, eight ports. The port of one device is connected to the port of another device via link comprising an optical fiber. Fibre Channel supports various link speeds measured in gigabits per second (Gbps), including 1 Gbps, 2 Gbps, 4 Gbps, 8 Gbps, 16 Gbps, and 32 Gbps among others. The host bus adapters (e.g., host bus adapters 126) of the endpoints of the Fibre Channel fabric may be a Fibre Channel adapter that enables the endpoints to communicate. A logical connection between device is referred to as a ‘path.’ When routing a packet (also referred to as a ‘frame’), each switch 114 forwards data packets from one network device to the next over a physical link, progressively moving them closer to their endpoint. In routing, a ‘next hop’ refers to the immediate neighbor or the next switch to which a packet is forwarded along its route. There may be multiple links corresponding to the multiple ports, which can be configured for different speeds. For example, there may be one or more 32 Gbps links and one or more 16 Gbps links, or one or more 8 Gbps links, between devices in the fabric.

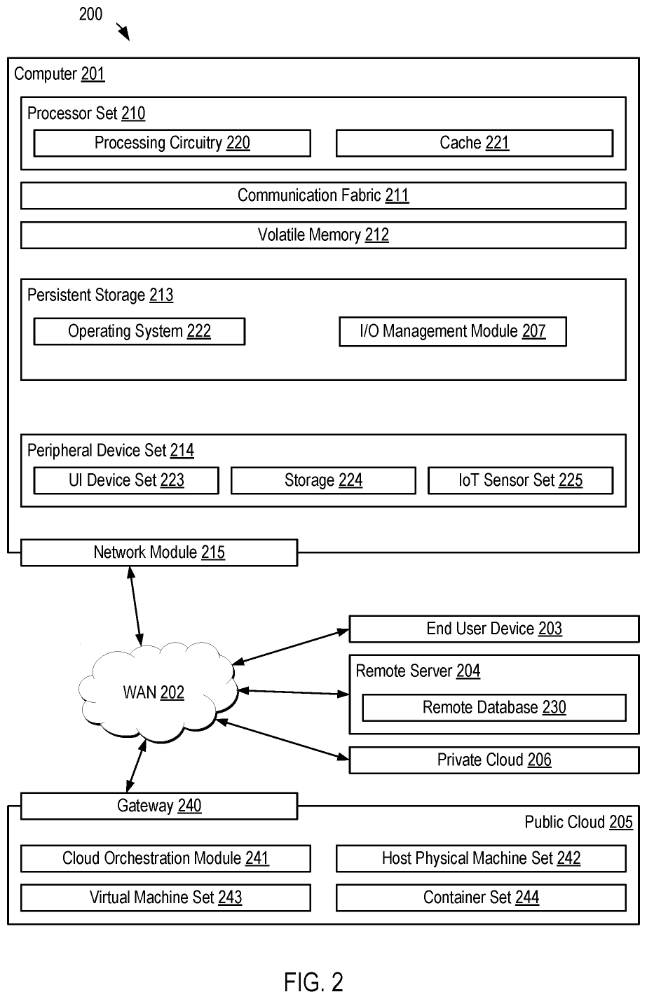

FIG. 2 sets forth an example computing environment according to aspects of the present disclosure. Computing environment 200 contains an example of an environment for the execution of at least some of the computer code involved in performing the various methods described herein, such as an input/output (I/O) management module 207. In addition to block 207, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and block 207, as identified above), peripheral device set 214 (including user interface (UI) device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

Computer 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 221 and the other storage media discussed below. The program instructions, and associated data, are accessed by processor set 210 to control and direct performance of the computer-implemented methods. In computing environment 200, at least some of the instructions for performing the computer-implemented methods may be stored in block 207 in persistent storage 213.

Communication fabric 211 is the signal conduction path that allows the various components of computer 201 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, volatile memory 212 is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface-type operating systems that employ a kernel. The code included in block 207 typically includes at least some of the computer code involved in performing the computer-implemented methods described herein.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database), this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the computer-implemented methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN 202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

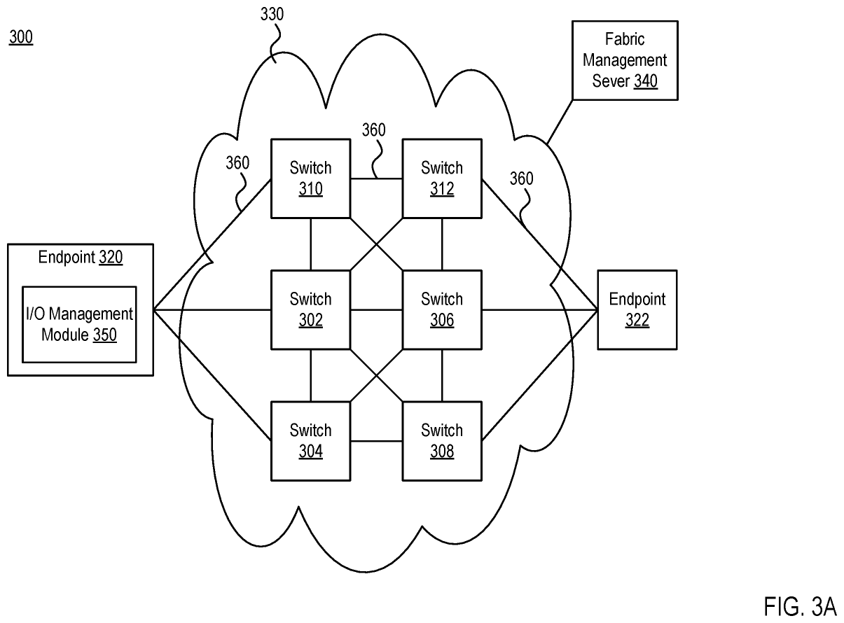

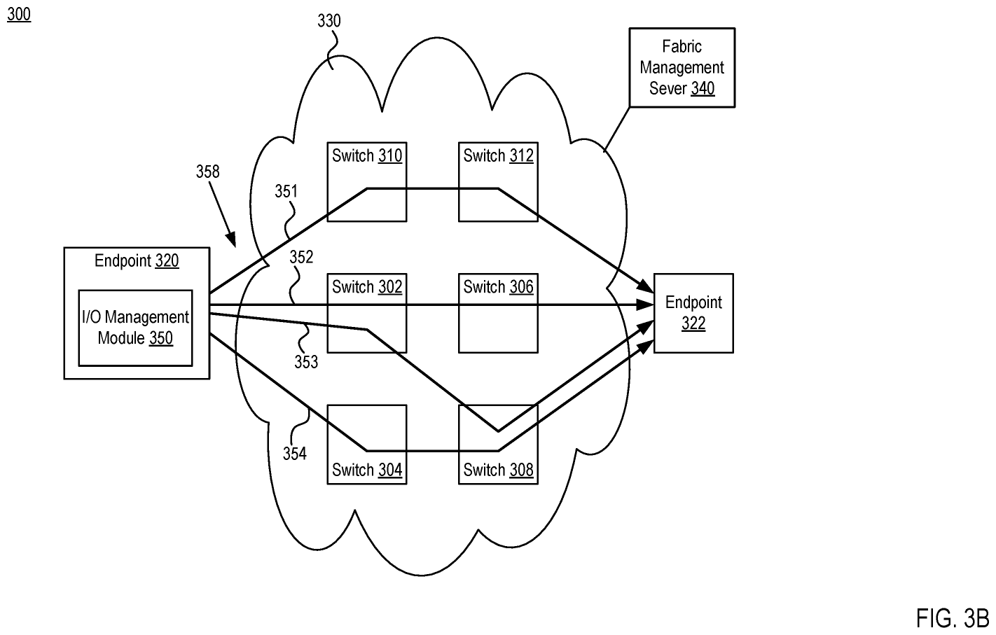

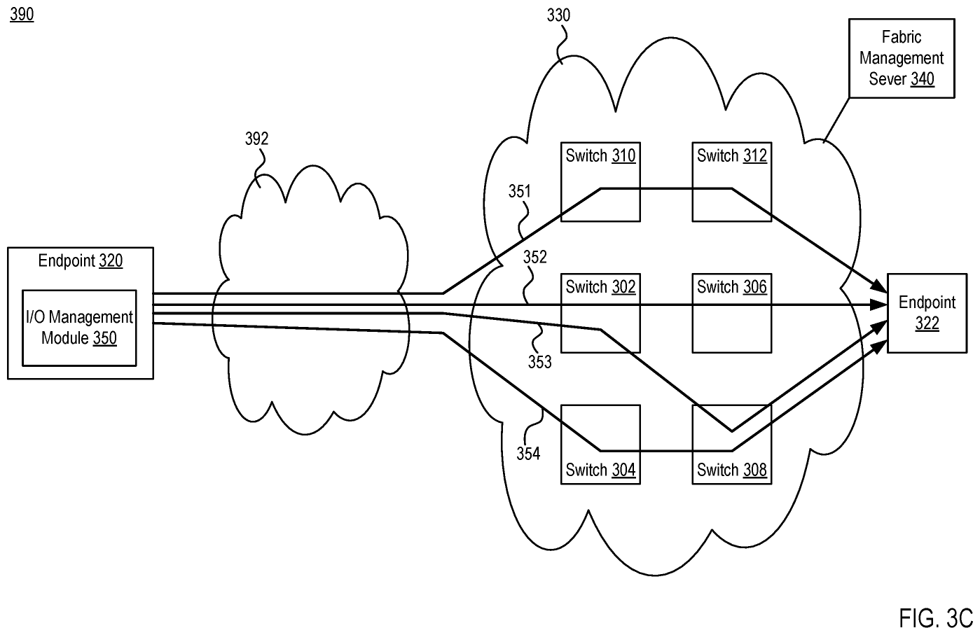

For further explanation, FIG. 3A sets forth a block diagram of an example network environment 300 for varying path group speed based on sustainability targets in accordance with at least one embodiment of the present disclosure. The network environment 300 is similar to the network environment 100 of FIG. 1, except that network environment 300 is shown with an example link topology. The example network environment 300 includes a fabric 330 coupling an initiator endpoint 320 (e.g., a host device) to a target endpoint 322 (e.g., a storage device). The fabric 330 includes switches 302, 304, 306, 308, 310, 312. Interconnection between the switches and between switches and endpoints is achieved by one or more physical links 360, where each link connects a port of one device to a port of another device. Although only one physical link 360 between devices is shown, it will be appreciated that a switch may include numerous ports and as such there may be more than one physical link between two devices. It will be further appreciated that two physical links between two devices may be configured to use different link speeds. In one example, the physical links 360 are optical links. A packet transmitted by endpoint 320 will be routed to the target endpoint 322 can be routed along one of a plurality of path that includes different sub combinations of switches 302, 304, 306, 308, 310, 312. In other words, connection between the endpoints 320, 322 is configured such that there are multiple paths through the fabric 330.

For further explanation, FIG. 3B sets forth a particular implementation of the network environment 300 of 3A. In the example of FIG. 3B, a path topology is shown. In the example of FIG. 3B, a path group 358 comprises redundant data paths 351, 352, 353, 354 between the endpoints 320, 322. Although the path group 358 is shown with four data paths, it will be appreciated that a path group can include any number of redundant data paths. In the example of FIG. 3B, data path 351 provides a link between endpoints 320, 322 through switch 310 and switch 312. Data path 352 provides a link between endpoints 320, 322 through switch 302 and switch 306. Data path 353 provides a link between endpoints 320, 322 through switch 302 and switch 308. Data path 354 provides a link between endpoints 320, 322 through switch 304 and switch 308.

Each data path 351, 352, 353, 354 is associated with a link speed of the path. In a typical operation, two endpoints will negotiate to the highest speed available. The highest speed may be determined by the physical capabilities of the hardware at either endpoint. As an illustrative example, the host bus adapter of endpoint 320 may be capable of 32 Gbps but the host bus adapter of endpoint 322 may only be capable of 16 Gbps. In such an example, the endpoints 320, 322 would negotiate a link speed of 16 Gbps. However, the link speed for a path may also be set by a configuration parameter. For example, an I/O management module can configure a path to use a link speed that is less than what is supported by the host bus adapters of the endpoints. As an illustrative example, a path may be configured such that its link speed is limited to 8 Gbps even though 16 Gbps is supported by both endpoints. When a path group is broad online, certain paths may be configured to use a lower link speed than other paths in the path group. One reason for this is to conserve energy when it is anticipated that the full bandwidth of each path will not be needed. Link speed configuration can be carried out by a host endpoint or a separate fabric management server 340.

When providing infrastructure-as-a-service to customers, that service is typically governed by a service level agreement (SLA). The SLA specifies service level requirements and targets for the customer. For example, service level requirements may be based on response or transaction times, redundancy, or service availability. Utilizing a maximum link speed for paths in the infrastructure ensures that service level requirements will be met, but also results in a higher degree of energy consumption. When a path in the infrastructure is part of a larger path that includes the customer's own network or other networks, the transaction latency experienced by the customer may be attributable to these other networks rather than the provided infrastructure.

Embodiments in accordance with aspects of the present disclosure leverage the variation in link speeds across the path group to identify when a lower link speed can be utilized without violating service level requirements. In some examples, an I/O management module 350 identifies when paths associated with slower link speeds are meeting service level requirements or targets and adjusts a path selection mechanism based on this information. When a packet is dispatched to the fabric, the I/O management may use a variety of path selection mechanisms to select a path from a path group. For example, a path selection mechanism is typically based on round robin selection, fastest-link first selection, shortest-path first selection, least-utilized path first selection, and so on, or based on a combination of these factors. To ensure SLA requirements are met and minimize transaction times, a path selection mechanism would typically favor a path with a faster link speed over a path with a slower link speed. Path selection mechanisms are not expected to utilize slowest-link first selection. In accordance with aspects of the present disclosure, the I/O management module 350 determines that a path having a link speed that is slower than other paths in the path group is still meeting service level requirements, and adjusts the path selection mechanism to favor paths in the path group that are associated the slower link speed. This reduces the overall energy demand the path group 358.

In some examples, the I/O management module 350 identifies a set of paths for a path group between the initiator endpoint 320 and the target endpoint 322. The I/O management module 350 configures the link speed for some or all of the ports such that at least some of the ports will negotiate to different link speeds. The I/O management module 350 brings the links online by establishing the links to/from the ports for each path in the path group. Once the paths are online, at least one path will operate at a slower link speed relative to other paths in the path group. In some examples, link speed information can be propagated to routing tables in fabric devices to aid in routing decisions. Assume, for the purpose of illustration, that path 351 is configured for 8 Gbps, path 352 is configured for 16 Gbps, path 353 is configured for 16 Gbps, and path 354 is configured for 32 Gbps.

In some examples, the I/O management module 350 monitors the end-to-end transaction times of packets that are routed through the fabric 330. The transaction time is an indicator of latency in the path. For example, a transaction time may be characterized as a command-response time, or the time it takes for the initiator endpoint 320 to issue a command to the target endpoint 322 and receive a response from the target endpoint 322. In some implementations, the I/O management module 350 monitors transaction times by observing command-response times associated with typical packets that routed over paths with different link speeds. In such implementations, a rolling average of the observed transaction times for each path is recorded. In other implementations, one or more test packets are transmitted over paths with different link speeds. For example, a test packet may be tagged within a header provided with the packet to aid in identifying that the packet is part of a test routine. In some examples, the average transaction time for a particular path is recorded as the transaction time or latency for that path. In other examples, the worst-case (e.g., longest transaction time) is recorded as the transaction time or latency for that path.

In some examples, the I/O management module 350 identifies service level requirements for transactions between the initiator endpoint 320 and the target endpoint 322. For example, the service level requirements may be indicated by data stored in a configuration file. In some implementations, the service level requirements indicate one or more of an end-to-end transaction time limit, a fabric latency limit, an availability requirement, a disaster recovery or failover requirement, and a redundancy requirement. The end-to-end transaction time limit may indicate a maximum amount of time allowable for an initiator endpoint to send a command to and receive a response from a target endpoint, whereas the fabric latency limit may indicate a maximum amount of latency attributable to the fabric. The availability requirement may be a required amount of bandwidth that is supported in the event of utilization spikes. The disaster recovery or failover requirement may indicate a maximum allowable time to transfer a workload from one path to another. The redundancy requirement may specify a number of redundant paths in a path group and/or the number of redundant paths in relation to average utilization of the paths.

In some examples, the I/O management module 350 determines the slowest link speed among the paths in the path group that is meeting the service level requirements. For example, the I/O management module 350 compares the service level requirements to the latency value associated with the path having the slowest link speed. In the above example, path 351 is associated with the slowest link speed (i.e., 8 Gbps). Thus, if the service level requirement for transaction time is 25 milliseconds and the latency value associated with path 351 is 20 milliseconds, the I/O management module 350 will determine that path 351 is still meeting its service level requirements even though it is the slowest path. As such, the other paths 352, 353, 354 in the path group 358 are overperforming. In some examples, if it is determined that any path is not meeting service level requirements, the link speed of that path can be increased, as discussed in more detail below.

In some examples, the I/O management module 350 adjusts the path selection mechanism based on the slowest link speed that is meeting the service level requirements among the paths in the path group. That is, the I/O management module 350 adjusts a selection mechanism to favor paths in the path group with slower link speeds than other paths in the path group. In some implementations, the path selection mechanism is adjusted by setting a path preference parameter for one or more paths that are preferred based on having a slower link speed. In other implementations, the path selection mechanism is adjusted by ranking the paths in the path group based on their link speed, where the top ranked path has the slowest link speed that meets service level requirements. In yet other implementations, the path selection mechanism is adjusted by configuring a path selection policy to always attempt the slowest-speed path first.

In some examples, the I/O management module 350 selects a path for a packet based on the adjusted path selection parameters. In these examples, the I/O management module 350 selects the preferred path based on its optimally low link speed and determines whether the packet can be transmitted using that path. If it cannot, due to the path being overutilized, congested, in a failure state, or otherwise non-optimal, the I/O management module 350 then selects another path having the same speed or the path with the next-slowest link speed. Thus, the I/O management module 350 effects a slowest-speed first path selection policy. In this way, power consumption is conserved, as faster links require more energy to maintain. Decreasing the reliance on the faster paths in the path group will also decrease the overall power consumption of the system.

Consider an illustrative example where path 351 is determined to meet service level requirements. In this example, because the link speed of path 351 is 8 Gbps, the I/O management module 350 adjusts a path selection mechanism to use a path selection policy, where that policy indicates to use the data path that has the slowest-link speed that is equal to or greater than 8 Gbps and that is also available. In selecting a path for a packet, the I/O management module 350 first determines whether path 351 is available. If it is not, due to failure, overutilization, or some other factor, the I/O management module 350 selects a path with the next lowest link speed and that is also available (i.e., path 352) and transmits the packet using that path. In some implementations, the paths can be ranked from lowest link speed to highest link speed, where the path with the highest rank is preferred. In such an example, the I/O management module 350 attempts to use the highest-ranked path first when selecting and utilizing a path to transmit the packet.

In some implementations, as shown in the network environment 390 of FIG. 3C, the data paths 351, 352, 353, 354 traverse a second network 392 between the endpoints 320, 322. As such, the second network 392 may be associated with its own latencies and bottlenecks that are distinct from those of the fabric 330. It may be the case that the link speeds of the data paths within the fabric 330 do not significantly impact end-to-end service level metrics. Thus, if it is determined that favoring lower link speeds in the fabric 330 will still meet service level requirements, then maintaining higher link speeds in the fabric 330 may be a waste of energy. That is, the higher link speeds may not be able to substantially improve the latency of the paths within the other network 392. Thus, the end-to-end latency using a low link speed path (e.g., path 351) can be compared to the end-to-end latency using a high link speed path (e.g., path 354) to determine the impact on the end-to-end latency. This information is useful in determining whether link speeds in the fabric 330 should be reduced.

In some implementations, the I/O management module 350 reduces the link speed of one or more paths in the path group. In a particular example, the I/O management module 350 reduces the link speed of one or more other higher-speed paths in the path group based on a path with a slower link speed meeting the service level requirements. Continuing the example above, upon determining that path 351 (an 8 Gbps path in path group 358) is meeting service level requirements, the I/O management module 350 may determine to reduce the speed of path 354 (a 32 Gbps path in path group 358). In this way, power consumption is conserved, as faster links require more energy to maintain. Decreasing the overall link speed of paths in the path group will also decrease the overall power consumption of the system.

In some implementations, the I/O management module 350 reduces the link speed of the path in response to determining that a utilization of the path has dropped below a threshold. In some examples, the reduction in link speed is based in part on an amount of headroom that should be maintained to guarantee availability in accordance with service level requirements. As an illustrative example, the I/O management module 350 may reduce a 16 Gbps link at 25% utilization to 8Gpbs resulting in 50% utilization, thus allowing for 50% buffer, instead of reducing to 4 Gbps resulting in 100% utilization. The amount of headroom to leave when reducing the link speed may depend on a level of redundancy in the path group. For example, the I/O management module 350 may determine that the amount of headroom increases as the number of redundant paths decreases and calculate the headroom accordingly.

The I/O management module 350 continues to monitor utilization of the paths over time. If the I/O management module 350 detects that utilization of a path has increased beyond a threshold, the link speed of the path is increased. To decrease or increase the link speed of a path, the workload on the path is quiesced and moved to another path. The path is then taken offline and the I/O management module 350 sets the port speed for the offline link. The path is then brought back online and workloads are moved back to the path.

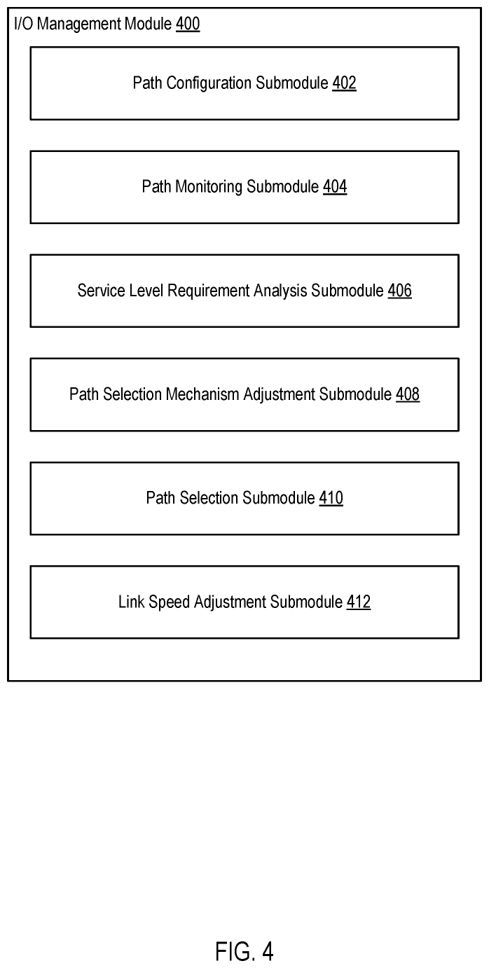

For further explanation, FIG. 4 sets forth a block diagram of an example I/O management module 400 in accordance with aspects of the present disclosure. The example I/O management module 400 includes a path configuration submodule 402. In some examples, the path configuration submodule 402 identifies paths and path groups between endpoints, sets port speeds for paths, and transitions paths between online and offline states, as discussed above. The example I/O management module 400 also includes a path monitoring submodule 404. In some examples, the path monitoring submodule 404 identifies paths in a path group where one path has a lower link speed than another path and monitors the paths to determine a latency as discussed above. In some implementations, the path monitoring submodule 404 executes test routines to determine end-to-end transaction times in the path. The example I/O management module 400 also includes a service level requirement analysis submodule 406. In some examples, the service level requirement analysis submodule 406 determines whether a path is meeting service level requirements. The example I/O management module 400 also includes a path selection mechanism adjustment submodule 408. In some examples, the path selection mechanism adjustment submodule 408 adjusts the path selection mechanism to favor a first path having a first link speed over a second path having a higher link speed when the first path meets service level requirements. The example I/O management module 400 also includes a path selection submodule 410. In some examples, the path selection submodule 410 implements the path selection mechanism and transmits packets based on the selected path. The example I/O management module 400 also includes a link speed adjustment submodule 412. In some examples, the link speed adjustment submodule 412 reduces link speed of a path when it is determined that a slower link speed is meeting service level requirements and/or when utilization of the path falls below a threshold. In some implementations, the link speed adjustment submodule 412 also computes an amount of headroom to leave available when reducing the link speed. In some examples, the link speed adjustment submodule 412 increases a link speed of a path when path utilization rises above a threshold.

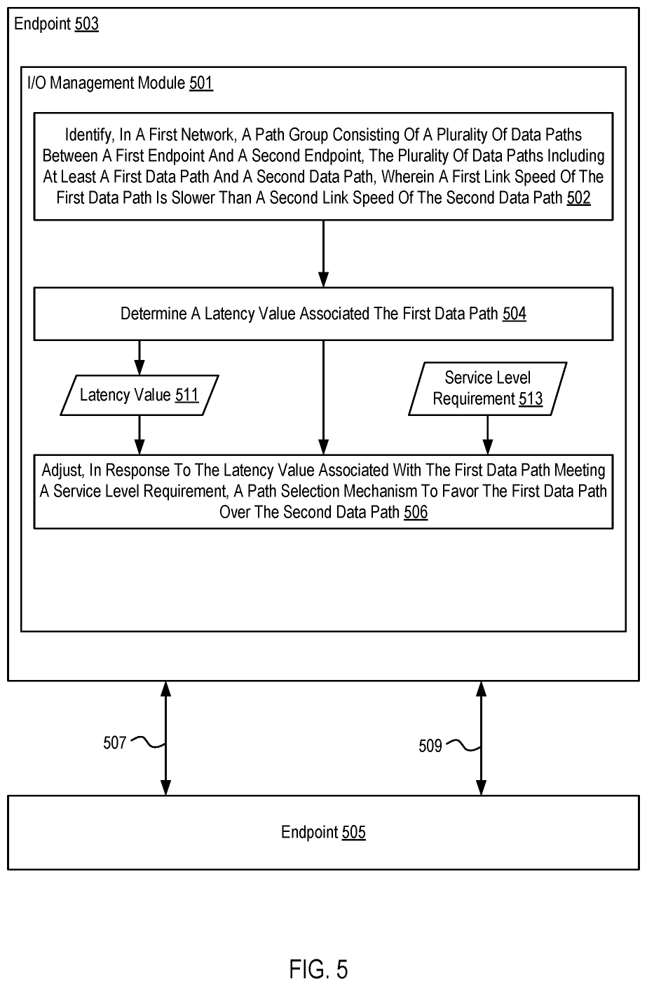

For further explanation, FIG. 5 sets forth a flow chart of an example method of varying path group speed based on sustainability targets in accordance with at least one embodiment of the present disclosure. The example of FIG. 5 includes an I/O management module 501 (e.g., the I/O management module 207 of FIG. 2, the I/O management module 350 of FIGS. 3A-3C, or the I/O management module 400 of FIG. 4). In the example of FIG. 5, the I/O management module 501 is located on an endpoint 503. However, it will be appreciated that the I/O management module 501 can be located on a different endpoint, on a management server, or on one or more fabric devices (e.g., switches, routers, etc.).

The example of FIG. 5 includes the endpoint 503 that is coupled to another endpoint 505 via two or more redundant data paths 507, 509 through a switched communications network (e.g., a Fibre Channel fabric). The data paths 507, 509 form a path group. In the example of FIG. 5, data path 507 is configured at a lower link speed than data path 509. For illustrative purposes, consider that data path 507 has a link speed of 16 Gbps and data path 509 has a link speed of 32 Gbps.

The method of FIG. 5 includes identifying 502, in a first network, a path group consisting of a plurality of data paths between a first endpoint and a second endpoint, the plurality of data paths 507, 509 including at least a first data path 507 and a second data path 509, wherein a first link speed of the first data path 507 is slower than a second link speed of the second data path 509. In some examples, to determine whether energy consumption across the network can be decreased, the I/O management module 501 identifies 502 a path group having variations in link speeds across the paths, in which a first data path 507 has a lower speed than a second data path 509. Link speeds can be determined from configuration data located on the endpoint or may be based on telemetry data from devices (e.g., switches) in the fabric.

The method of FIG. 5 also includes determining 504 a latency value 511 associated the first data path 507. In some examples, the I/O management module 501 determines 504 the latency value 511 by monitoring latencies associated with packet traffic across the path 507. In other examples, the I/O management module 501 measures latencies of a test packets that are transmitted across the path 507. In some examples, the latency value corresponds to a transaction time or command-response time, or other duration of time indicative of latency in a path.

The method of FIG. 5 also includes adjusting 506, in response to the latency value 511 associated with the first data path meeting a service level requirement 513, a path selection mechanism to favor the first data path 507 over the second data path 509. The I/O management module 501 compares a latency requirement of the service level requirement to the latency value of the first data path 507. When the latency requirement is met by the first data path 507, the I/O management module 501 adjusts 506 a path selection mechanism to favor the first path 507 over the second data path 509. In some examples, the I/O management module 501 adjusts 506 a path selection mechanism to favor the first data path 507 over the second data path 509 by setting a preference parameter for one or more paths that are preferred based on the path having a slower link speed. In other implementations, the path selection mechanism is adjusted by ranking the paths in the path group based on their link speed, where the top ranked path has the slowest link speed that meets service level requirements. In yet other implementations, the path selection mechanism is adjusted by configuring a path selection policy to always attempt the slowest-speed path first.

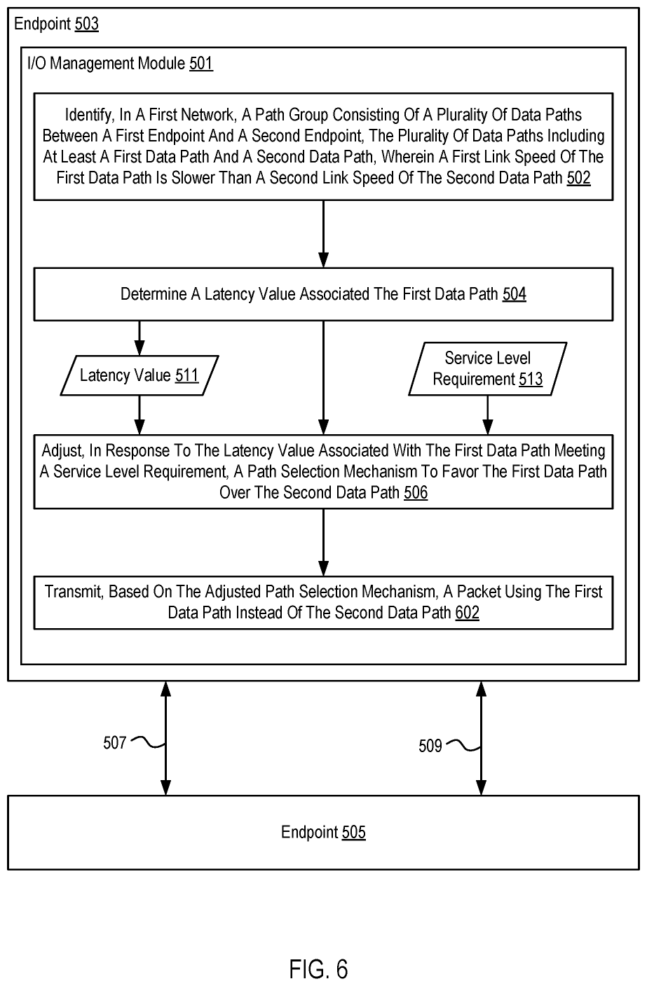

For further explanation, FIG. 6 sets forth a flow chart of an example method of varying path group speed based on sustainability targets in accordance with at least one embodiment of the present disclosure. The example method of FIG. 6 extends the method of FIG. 5 in that the example method of FIG. 6 also includes transmitting 602, based on the adjusted path selection mechanism, a packet using the first data path 507 instead of the second data path 509. In some examples, the I/O management module 501 transmits 602 the packet using the first data path 507 instead of the second data path 509 by determining that the first data path 507 is preferred over the second data path, as discussed above. In such examples, the I/O management module 501 also determines whether the first data path 507 is available. For example, if the first data path is overutilized or experiencing a failure state, the I/O management module 501 may determine that the first data path 507 is not available. If the first data path 507 is available, the I/O management module 501 causes the packet to be transmitted to the endpoint 505 using the first data path 507. If the first data path is not available, the I/O management module 501 may select the next-most preferred path or the path with the next-slowest link speed to transmit the packet without selecting the second data path 509. For example, a third data path may have a link speed that is faster than the first path 507 but slower than that of the second data path 509, in which case the third data path would be preferable over the second data path 509 if the first data path 507 was not available.

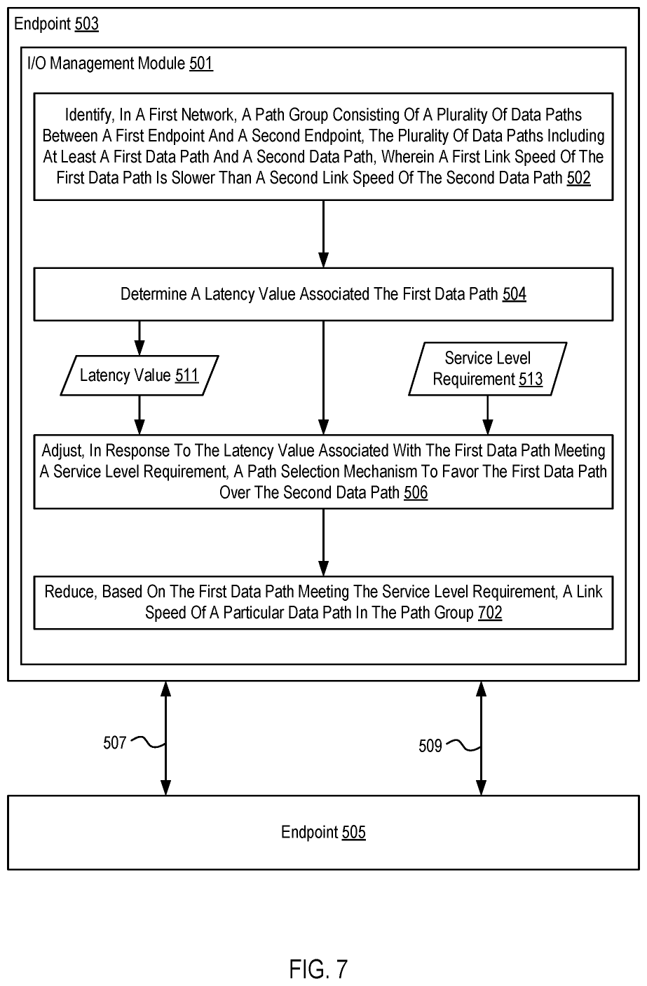

For further explanation, FIG. 7 sets forth a flow chart of an example method of varying path group speed based on sustainability targets in accordance with at least one embodiment of the present disclosure. The example method of FIG. 7 extends the method of FIG. 5 in that the example method of FIG. 7 also includes reducing 702, based on the first data path 507 meeting the service level requirement 513, a link speed of a particular data path in the path group. In some examples, upon determining that the first data path 507 is meeting the service level requirement 513, the I/O management module 501 identifies a particular data path having a link speed that is higher than that of the first data path and reduces 702 the link speed of that particular data path. For example, the I/O management module 501 may reduce the link speed of the second data path 509 in response to determining that the first data path 507 can meet the service level requirement 513 using a slower link speed.

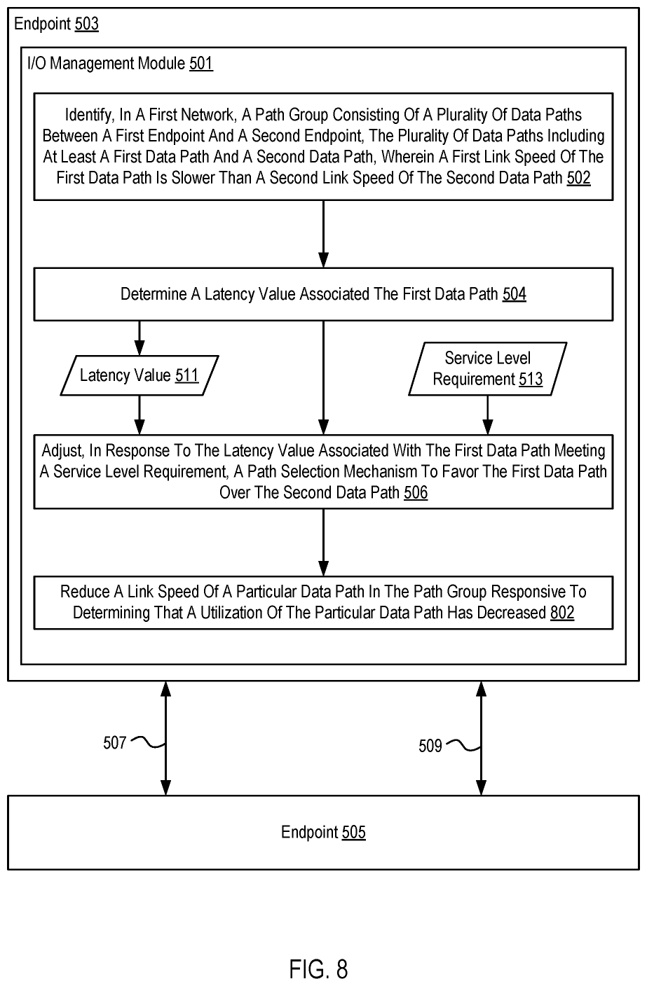

For further explanation, FIG. 8 sets forth a flow chart of an example method of varying path group speed based on sustainability targets in accordance with at least one embodiment of the present disclosure. The example method of FIG. 8 extends the method of FIG. 5 in that the example method of FIG. 8 also includes reducing 802 a link speed of a particular data path in the path group responsive to determining that a utilization of the particular data path has decreased. In some examples, the I/O management module 501 detects when a utilization of a particular data path has decreased below a preconfigured threshold. The utilization can be computed based on a rolling average, through historical trend analysis, and so on. In response, the I/O management module 501 reduces 802 the link speed of a particular data path. In some implementations, the amount of reduction in the link speed is computed in part based on an amount of headroom that should be maintained to guarantee availability in accordance with service level requirements. As an illustrative example, the I/O management module 501 may reduce a 16 Gbps link at 25% utilization to 8 Gpbs resulting in 50% utilization, thus allowing for 50% buffer, instead of reducing to 4 Gbps resulting in 100% utilization. The amount of headroom to leave when reducing the link speed may depend on a level of redundancy in the path group. For example, the I/O management module 501 may determine that the amount of headroom increases as the number of redundant paths decreases and calculate the headroom accordingly.

In view of the foregoing, it will be appreciated that embodiments in accordance with the present disclosure advantageously reduce the energy demand associated with transporting data, advance sustainability goals, and improve the overall performance and efficiency of the data transport system by optimizing the link speeds of data paths. The I/O management module identifies when paths associated with slower link speeds are meeting service level requirements and adjusts a path selection mechanism based on this information. Instead of using round robin or some other path selection policy, the I/O management module adjusts the path selection mechanism to favor paths in the path group that are associated the slower link speed in order to reduce energy consumption. Thus, embodiments optimize the energy demand of data transport by determining which paths are overachieving service level targets, thus consuming more power than needed, and favoring paths with a smaller energy demand. Further, data path link speeds are reduced based on utilization, which also reduces energy consumption.

One such embodiment that provides these advantages is directed to a method of varying path group speed based on sustainability targets. The method includes identifying, in a first network, a path group consisting of a plurality of data paths between a first endpoint and a second endpoint. The plurality of data paths includes at least a first data path and a second data path, where a first link speed of the first data path is slower than a second link speed of the second data path. The method also includes determining a latency value associated the first data path. The method also includes adjusting, in response to the latency value associated with the first data path meeting a service level requirement, a path selection mechanism to favor the first data path over the second data path. In this way, the energy demand of data transport can be optimized by determining which paths are overachieving service level targets, and thus consuming more power than needed, and adjusting path selection mechanisms to favor paths that are associated with a relatively smaller energy demand thus increasing the energy efficiency of the path group. In some examples, the first network is storage area network that utilizes a Fibre Channel policy.

In some variations, the path selection mechanism is adjusted by setting a preference parameter indicating a preference for at least one of a link speed and a data path. In other variations, the path selection mechanism is adjusted by adjusting a ranking of the plurality of data paths in the path group. In still other variations, the path selection mechanism is adjusted by changing a path selection policy.

In some examples, the method also includes transmitting, based on the adjusted path selection mechanism, a packet using the first data path instead of the second data path.

In some variations, the latency value is based on an end-to-end transaction time for packets transmitted from the first endpoint to the second endpoint. In some examples, the plurality of data paths traverses the first network and a second network, and a latency of a path accounts for a first latency within the first network and a second latency within the second network.

In some variations, the method also includes reducing, based on the first data path meeting the service level requirement, a link speed of a particular data path in the path group. In some variations, the method includes reducing a link speed of a particular data path in the path group responsive to determining that a utilization of the particular data path has decreased. In some examples, an amount of reduction in the link speed is determined based on a utilization of the particular path and a predetermined headroom. In this way, path utilization information and service level metrics are used can reduce the link speed of paths that are overachieving service level targets, thus increasing the energy efficiency of the path group.

Embodiments in accordance with aspects of the present disclosure leverage a variation in link speeds across redundant path to identify when a lower link speed can be utilized without violating service level requirements. In some examples, an input/output (I/O) management module identifies when paths associated with slower link speeds are meeting service level requirements and adjusts a path selection mechanism based on this information. Instead of using round robin or some other path selection policy, the I/O management module adjusts the path selection mechanism to favor paths in the path group that are associated the slower link speed. The I/O management module can also reduce the link speed of a path in response to determining that the path is overachieving the service level requirements, or in response to determining that the path is underutilized. By reducing link speeds, energy demand associated with transporting data is reduced, thereby advancing sustainability goals, and the overall performance and efficiency of the data transport system is improved.

Another embodiment is directed to an apparatus comprising: a processing device; and memory operatively coupled to the processing device, wherein the memory stores computer program instructions that, when executed, cause the processing device to identify, in a first network, a path group consisting of a plurality of data paths between a first endpoint and a second endpoint, the plurality of data paths including at least a first data path and a second data path, where a first link speed of the first data path is slower than a second link speed of the second data path. The computer program instructions further configure the processing device to determine a latency value associated the first data path. The computer program instructions further configure the processing device to adjust, in response to the latency value associated with the first data path meeting a service level requirement, a path selection mechanism to favor the first data path over the second data path.

Another embodiment is directed to a computer program product comprising a computer readable storage medium, wherein the computer readable storage medium comprises computer program instructions that, when executed, identify, in a first network, a path group consisting of a plurality of data paths between a first endpoint and a second endpoint, the plurality of data paths including at least a first data path and a second data path, wherein a first link speed of the first data path is slower than a second link speed of the second data path. When executed, the computer program instructions determine a latency value associated the first data path. When executed, the computer program instructions adjust, in response to the latency value associated with the first data path meeting a service level requirement, a path selection mechanism to favor the first data path over the second data path.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
identifying, in a first network, a path group consisting of a plurality of data paths between a first endpoint and a second endpoint, the plurality of data paths including at least a first data path and a second data path, wherein a first link speed of the first data path is slower than a second link speed of the second data path;
determining a latency value associated the first data path; and
adjusting, in response to the latency value associated with the first data path meeting a service level requirement, a path selection mechanism to favor the first data path over the second data path.

2. The method of claim 1, wherein the path selection mechanism is adjusted by setting a preference parameter indicating a preference for at least one of a link speed and a data path.

3. The method of claim 1, wherein the path selection mechanism is adjusted by adjusting a ranking of the plurality of data paths in the path group.

4. The method of claim 1, wherein the path selection mechanism is adjusted by changing a path selection policy.

5. The method of claim 1 further comprising:
transmitting, based on the adjusted path selection mechanism, a packet using the first data path instead of the second data path.

6. The method of claim 1, wherein the latency value is based on an end-to-end transaction time for packets transmitted from the first endpoint to the second endpoint.

7. The method of claim 6, wherein the plurality of data paths traverses the first network and a second network; and wherein a latency of a path accounts for a first latency within the first network and a second latency within the second network.

8. The method of claim 1 further comprising:
reducing, based on the first data path meeting the service level requirement, a link speed of a particular data path in the path group.

9. The method of claim 1 further comprising:
reducing a link speed of a particular data path in the path group responsive to determining that a utilization of the particular data path has decreased.

10. The method of claim 9, wherein an amount of reduction in the link speed is determined based on a utilization of the particular data path and a predetermined headroom.

11. The method of claim 1, wherein the first network is storage area network that utilizes a Fibre Channel policy.

12. An apparatus comprising:
a processing device; and
memory operatively coupled to the processing device, wherein the memory stores computer program instructions that, when executed, cause the processing device to:
identify, in a first network, a path group consisting of a plurality of data paths between a first endpoint and a second endpoint, the plurality of data paths including at least a first data path and a second data path, wherein a first link speed of the first data path is slower than a second link speed of the second data path;
determine a latency value associated the first data path; and
adjust, in response to the latency value associated with the first data path meeting a service level requirement, a path selection mechanism to favor the first data path over the second data path.

13. The apparatus of claim 12, wherein the computer program instructions, when executed, cause the processing device to:
transmit, based on the adjusted path selection mechanism, a packet using the first data path instead of the second data path.

14. The apparatus of claim 12, wherein the computer program instructions, when executed, cause the processing device to:
reduce, based on the first data path meeting the service level requirement, a link speed of a particular data path in the path group.

15. The apparatus of claim 12, wherein the computer program instructions, when executed, cause the processing device to:
reduce a link speed of a particular data path in the path group responsive to determining that a utilization of the particular data path has decreased.

16. The apparatus of claim 12, wherein the first network is storage area network that utilizes a Fibre Channel policy.

17. A computer program product comprising a computer readable storage medium, wherein the computer readable storage medium comprises computer program instructions that, when executed:
identify, in a first network, a path group consisting of a plurality of data paths between a first endpoint and a second endpoint, the plurality of data paths including at least a first data path and a second data path, wherein a first link speed of the first data path is slower than a second link speed of the second data path;
determine a latency value associated the first data path; and
adjust, in response to the latency value associated with the first data path meeting a service level requirement, a path selection mechanism to favor the first data path over the second data path.

18. The computer program product of claim 17, wherein the computer program instructions, when executed:
transmit, based on the adjusted path selection mechanism, a packet using the first data path instead of the second data path.

19. The computer program product of claim 17, wherein the computer program instructions, when executed:
reduce, based on the first data path meeting the service level requirement, a link speed of a particular data path in the path group.

20. The computer program product of claim 17, wherein the computer program instructions, when executed:
reduce a link speed of a particular data path in the path group responsive to determining that a utilization of the particular data path has decreased.
